(19) United States
(12) Patent Application Publication
(10) Pub. No.: US 2026/0359718 A1
(43) Pub. Date: Nov. 12, 2026

(54) AIR TO ROAD BOOTSTRAP LEARNING FOR DRIVING

(71) Applicant: AUTOBRAINS TECHNOLOGIES LTD, Tel Aviv-Yafo (IL)

(72) Inventor: Igal RAICHELGAUZ, Tel Aviv (IL)

(73) Assignee: AUTOBRAINS TECHNOLOGIES LTD, Tel Aviv-Yafo (IL)

(21) Appl. No.: 19/204,627

(22) Filed: May 12, 2025

(51) Int. Cl. G06N 20/00; G06V 20/56

(52) U.S. Cl. CPC G06N 20/00; G06V 20/588

(57) ABSTRACT

A method of air to road bootstrap learning for driving, the method includes obtaining, at a processor implementing a ground perception artificial intelligence model, road element location information for a given road element in air perception information of air based data that is collected at an identified location, in a region of view, wherein the road element location information is determined by using air to ground based localization of a vehicle in the region of view; and performing an iterative process of learning iterations for autonomous driving, while at each learning iteration increasing a distance range of the ground perception artificial intelligence model in the region of view associated with the learning iteration from preceding learning iterations to another.

### BACKGROUND

Ground perception systems enable an autonomous vehicle to understand and interpret its environment using sensor data. According to an embodiment, the ground perception artificial intelligence model is a core part of the autonomous vehicle's autonomy stack, responsible for turning raw data from a sensing unit of the autonomous vehicle (for example having one or more sensors such as cameras, LiDAR, radar, and ultrasonic sensors) into a structured representation of the surrounding world.

Training the ground perception systems solely on sensed information gathered from ground vehicle has its limitations—as this type of sensed information may suffer from occlusions, reduced accuracy at the distance of sensed road elements from the sensing unit increased, inconsistent perception decisions, and the like.

There is a need to improve the training process of the ground perception system.

### SUMMARY

There is provided a method, a non-transitory computer readable medium and a system as illustrated in the application.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a computerized system;

FIG. 2 illustrates an example of a vehicle;

FIG. 3 illustrates an example of a method; and

FIG. 4A. 4B, and 4C illustrate examples of three learning iterations.

### DETAILED DESCRIPTION

There is provided a method, a non-transitory computer readable medium and a system for improving the training of a ground perception artificial intelligence model by using an iterative process that uses both air based data and ground view data.

In the content of image processing, precision provides an indication of how many of the detected road elements are actually correct while recall provides an indication of how many of the actual relevant road elements were detected. Precision may be calculated by dividing the true positives by a sum of the true positives and false positives. Recall may be calculated by dividing the true positives by a sum of the true positives and false negatives. There is usually a tradeoff between precision and recall. For example—high recall often comes at the cost of lower precision—as to capture all relevant instances (maximize recall), the system may label more things as positive, including many incorrect ones—leading to more false positives and hence lower precision. Yet for another example—high precision often comes at the cost of lower recall—To be very sure that positive labels are correct (maximize precision), the system may be conservative, labeling fewer positives overall—missing some true positives and thus lowering recall.

Processing air based data and ground view data may provide different tradeoffs between precision and recall—the air based data associated with lower precision in relation to the ground view data but with a higher recall.

The usage of both air based data and ground view data benefits from higher precision and higher recall.

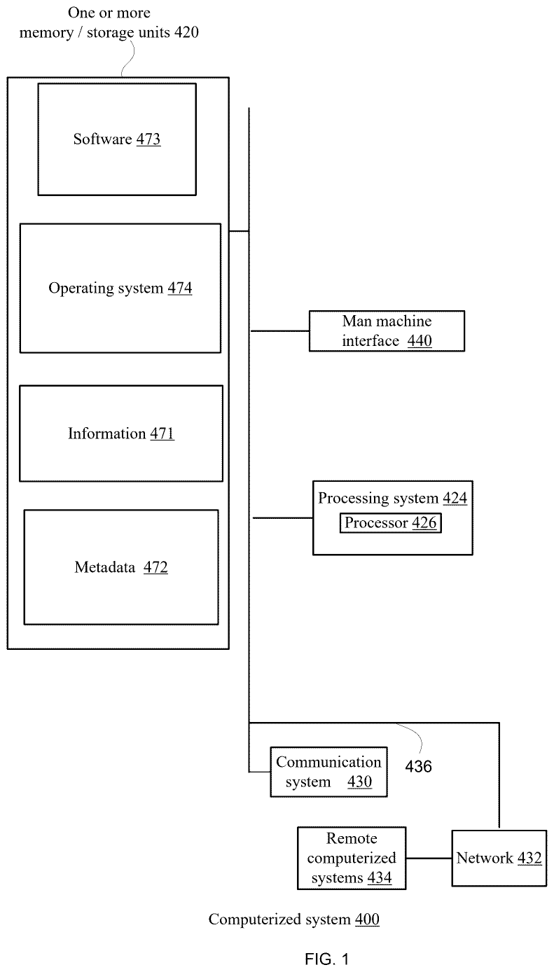

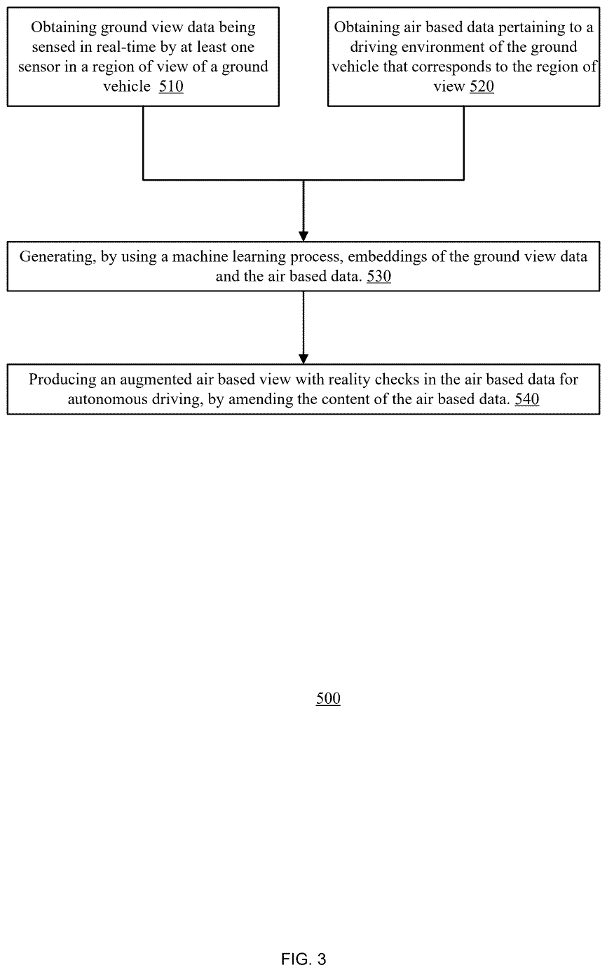

FIG. 1 illustrates an example of a computerized system 400 that is configured to execute at least some of the steps of method 500 of FIG. 3.

Computerized system 400 includes a man machine interface 440 having or being in communication with man machine interface (MMI) controller (not shown), a communication system 430, one or more memory and/or storage units 420, a processing system 424 including processor 426. The computerized system may be a server, a laptop, a desktop or any other computer and may include or be in communication with a sensing unit and/or a controller.

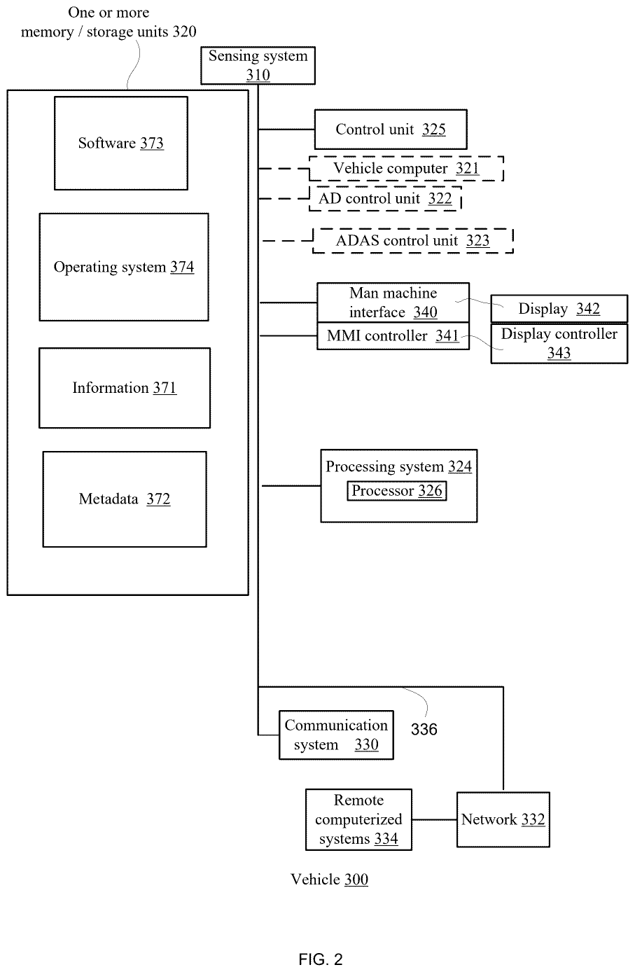

According to an embodiment, computerized system 400 is in communication with network 432 and one or more other remote computerized systems 434 that are in communication with network 432. An example of a remote computerized system is a vehicle (such as vehicle 300 of FIG. 2), a server or one or more computers having access to a storage system.

The memory and/or storage units 420 was shown as storing software. Any reference to software should be applied mutatis mutandis to code and/or firmware and/or instructions and/or commands, and the like.

Processor 426 includes a plurality of processing units 426(1)-426(J), J is an integer that exceeds one. Any reference to one unit or item should be applied mutatis mutandis to multiple units or items. For example—any reference to processor should be applied mutatis mutandis to multiple processors, any reference to communication system 430 should be applied mutatis mutandis to multiple communication systems.

According to an embodiment, the memory and/or storage units 420 stores at least one of: operating system 474, information 471, metadata 472, and software 473.

According to an embodiment, processing system 424 is configured to perform any method illustrated in the application while executing software.

FIG. 2 illustrates an example of vehicle 300 configured to utilize the augmented air based view generated by method 500 of FIG. 3 and/or to participate in the execution of method 500.

Vehicle 300 includes a man machine interface 340 having or being in communication with man machine interface (MMI) controller 341, wherein in FIG. 1 the MMI is a display 342 or includes a display 342 and the MMI controller is a display controller 343 or includes the display controller 343, a communication system 330, one or more memory and/or storage units 320, a processing system 324 including processor 326. The communication system 330, the one or more memory and/or storage units 320, and the processing system 324 may belong to a computerized system of vehicle 300. The computerized system may be a server, a laptop, a desktop or any other computer and may include or be in communication with a sensing unit and/or a controller.

According to an embodiment, vehicle 300 is in communication with network 332 and one or more other remote computerized systems 334 that are in communication with network 332. An example of a remote computerized system is a server or one or more computers having access to a storage system that stores items related to one or more portions of one or more groups of neural networks—at least some of which are not currently stored in the vehicle.

According to an embodiment, the memory and/or storage unit 320 stores at least one of: operating system 374, information 371, metadata 372, and software 373.

The control unit 325 may cooperate with ADAS control unit 323 and/or with AD control unit 322 and/or may control or communicate with other vehicle components—including vehicle computer.

The ADAS control unit 323 is configured to control ADAS operations.

The AD control unit 322 is configured to control autonomous driving of the autonomous vehicle.

The vehicle computer 321 is configured to control the operation of the vehicle—especially controlling the engine, the transmission, and any other vehicle system or component.

The vehicle computer 321 may be in communication with an engine control module, a transmission control module, a powertrain control module, and the like.

FIG. 3 illustrates an example of method 500 of providing air to road bootstrap learning for driving, the method is computer implemented.

According to an embodiment, method 500 includes step 510 of obtaining, at a processor implementing a ground perception artificial intelligence model, road element location information for a given road element in air perception information of air based data that is collected at an identified location, in a region of view, wherein the road element location information is determined by using air to ground based localization of a vehicle in the region of view.

The ground perception artificial intelligence model, following the learning, is for use for autonomous driving of ground vehicles.

The ground perception artificial intelligence model, following the learning, is configured generate and/or request and/or determine and/or instruct and/or trigger and/or control and/or transmit and/or output and/or perform at least one autonomous or non-autonomous driving related operation is associated with the artificial intelligence models below a maturity level, and/or driving along the path—for example in compliant with one or more levels of autonomous driving—such as L2, L2+, L2++, L3 or L4 autonomous driving.

According to an embodiment, the ground perception artificial intelligence model has at least one of the following key functions: (a) object detection and classification—identifies and labels vehicles, pedestrians, cyclists, traffic signs, animals, and other objects in the environment, (b) object tracking—predicts the motion and trajectory of detected objects over time, (c) semantic segmentation—labels each pixel in an image with a category (e.g., road, sidewalk, lane markings), (d) depth estimation/three dimensional perception—determines the distance and three dimensional position of objects using stereo vision, LiDAR point clouds, or radar data, (e) sensor fusion—combines data from multiple sensors of at least the autonomous vehicle to improve accuracy and robustness (e.g., combining LiDAR and camera outputs to better detect a car in fog).

The ground perception artificial intelligence model may be implemented in various manners such as convolutional Neural Networks for image-based tasks, PointNet and its variants for processing LiDAR point clouds, transformers for temporal and multi-sensor context understanding or recurrent neural networks or long short-term memory which is a type of recurrent neural network architecture designed to model sequences and remember information over long time periods.

Step 510 includes determining the location of the vehicle with high accuracy—which then allow to locate road elements sensed by the vehicle with high accuracy.

As indicated above—step 510 includes locating road element location information for a given road element in air perception information of air based data that is collected at an identified location, in a region of view, wherein the road element location information is determined by using air to ground based localization of a vehicle in the region of view According to an embodiment, step 510 is based on a movement estimate of the vehicle and on probabilistic location information indicative of a location of the vehicle within the air based data. An example of the generating of the localization information is illustrated in U.S. patent application Ser. No. 18/527,701 filed on Dec. 4, 2023, which is incorporated herein by reference.

According to an embodiment, step 510 is followed by step 520 of performing an iterative process of learning iterations for autonomous driving, while at each learning iteration increasing a distance range of the ground perception artificial intelligence model in the region of view associated with the learning iteration from preceding learning iterations to another.

It has been surprisingly found that by performing an iterative learning process allows to reduces the errors associated with the learning as during each iteration the ground perception artificial intelligence model overcome inaccuracies associated with the previous iteration.

According to an embodiment, at each learning iteration of the iterative process:
Inferring, using the road element location information, ground perception information for the given road element in the air perception information, by projecting the road element location information on a ground image pertaining to the given road object in the region of view.
Correcting, based on the inferring at each learning iteration and contingent on a determined detection threshold, a detection operation of a detector of the ground perception artificial intelligence model trained using ground data for detection of the given road element, by applying the ground image with the projected road element location information in the detection operation of the detector.

According to an embodiment, in order to use the two types of perception information (ground perception information and the air perception information) there is a need to align the ground perception information and the air perception information—for example to align the coordinates of road elements captured in the ground perception information with coordinates of road elements captured in the ground perception information. The alignment (also known is registration) includes transforming at least one of the coordinate systems to a shared coordinate system—the shared coordinate system being one of the ground perception information coordination system or the air perception information coordination system—or using a shared coordinate system that differ from either one of said coordinate systems.

According to an embodiment the alignment may include using one or more (preferable two or more) road elements that appear in both type of perception information as anchors. According to an embodiment when the same two or more road element that can be used as anchors (for example static road elements) appear in both types of perception information—their relative location in each one of data may be used to compensate for tilted or oriented surface or road on which they appear.

According to an embodiment, the projecting of the road element location information on a ground image pertaining to the given road object in the region of view is an example of such an alignment.

According to an embodiment, the inferring is followed by improving the accuracy of the ground perception artificial intelligence model by correcting, based on the inferring at each learning iteration and contingent on a determined detection threshold, a detection operation of a detector of the ground perception artificial intelligence model. The improvement may include using a loss function to overcome errors resulting from the ground perception information using the air perception information.

According to an embodiment, and in order to increase the accuracy of the training may be conditions by having perception information that exhibits at least a define amount of credibility (or trust or accuracy)—thus the updating of the detection operation (applied by the ground perception artificial intelligence model) may be conditioned by a determined detection threshold.

As indicated above—the ground perception artificial intelligence model is trained using ground data for detection of the given road element, by applying the ground image with the projected road element location information in the detection operation of the detector.

According to an embodiment the alignment may involve other projections—that among to a projection to a shared space that may differ from the ground perception information coordinate system.

According to an embodiment, step 520 allows the ground perception information and the air perception information to be combined and interpreted in a common reference frame. Accordingly, step 520 may use at least one of (a) coordinate system transformation that involves converting measurements from one sensor's coordinate system to another. Common transformations include translation, rotation, and scaling; (b) sensor calibration—each sensor should be individually calibrated to determine its intrinsic parameters and any systematic errors or biases, (c) using one or more registration techniques such as Iterative Closest Point (ICP) or point cloud registration can be used to align the different perception information, (d) using homogeneous transformations for representing and combining multiple coordinate transformations in a single matrix operation, (e) performing error propagation—understanding how errors in individual sensor measurements propagate through the alignment process is important for assessing overall accuracy, (f) applying sensor-specific considerations: different sensing modalities (e.g., cameras, LiDAR, IMUs, GPS) may require specific alignment techniques due to their unique characteristics and data formats.

According to an embodiment, the ground perception information is obtained from one vehicle—but is has been found that obtaining ground perception information from multiple vehicles is better. The latter allows for the creation of more robust and adaptable ground perception artificial intelligence model.

Accordingly—large amounts of ground perception information can be collected from various sensors installed in different vehicles. These sensors may include cameras, LiDAR, radar, GPS, and other onboard systems. The data collected encompasses a wide range of driving conditions, environments, and scenarios, providing a diverse dataset for training. This approach offers several advantages: (a) improved generalization—by incorporating data from multiple vehicles, the AI model can learn to handle a broader range of situations and environments, leading to better performance across different driving conditions; (b) faster learning—with data from numerous vehicles, the artificial intelligence model can be exposed to a larger number of scenarios in a shorter time, potentially accelerating the learning process; (c) continuous improvement—as more data is collected and processed, the ground perception artificial intelligence model can be updated and refined over time, leading to ongoing improvements in performance and capabilities, (d) scalability: this approach allows for the development of ground perception artificial intelligence model that can benefit from the experiences of entire fleets of vehicles, potentially leading to rapid advancements in autonomous driving technology.

According to an embodiment, the inferring, at each learning iteration of the iterative process, the ground perception information is with respect to a distance range that is larger than a preceding learning iteration. The distance range refers to distances between the ego vehicle and road elements—and each iteration may ignore road elements located outside the distance range. During the iterative process the ground perception artificial intelligence model is trained to correctly detect and determine location of road elements within the distance range associated with the iteration. For example, assuming that the ground perception artificial intelligence model is accurate for up to 20 meters from the ego vehicle, a following iteration will train the ground perception artificial intelligence model to be accurate for more than 20 meters—for example for 25 meters.

According to an embodiment the detector is a lane detection model, and ground perception information and the air perception information are indicative of the location of the lane (especially the locations of lane and/or road boundaries). The ground perception information may include one or more a lane markings that are indicative of the location of lane and/or road boundaries.

According to an embodiment, the perception system of the ground vehicle may be situation sensitive—for example—the ground perception artificial intelligence model may be differently trained for different scenarios and/or there may be different ground perception artificial intelligence models that are associated with different scenarios. In these cases wherein the inferring, at each learning iteration of the iterative process, the ground perception information is further in accordance with sensed data pertaining to a determined driving scenario in the region of view.

The iterative process may be applicable to a same region of view throughout. As such, for example, the iterative process of the air to road bootstrap learning pertains to a same given road segment, or road location throughout. In particularly, the learning iterations of the iterative process is involved with the inferring of ground perception information for a given road element, and further correcting a detection of the road element, in a particular location of view throughout the iterative process.

The iterative process may be further applicable to an additional region of view, beyond the particular region of view, such as an additional road segment or location in view, that is similar to the particular region of view. As such, for example, the learning iterations of the iterative process for inferring ground perception information for a given road element, and further correcting a detection of the road element, may be associated with road elements in additional locations of view, for example to road segments identified in correspondence to the particular location of view.

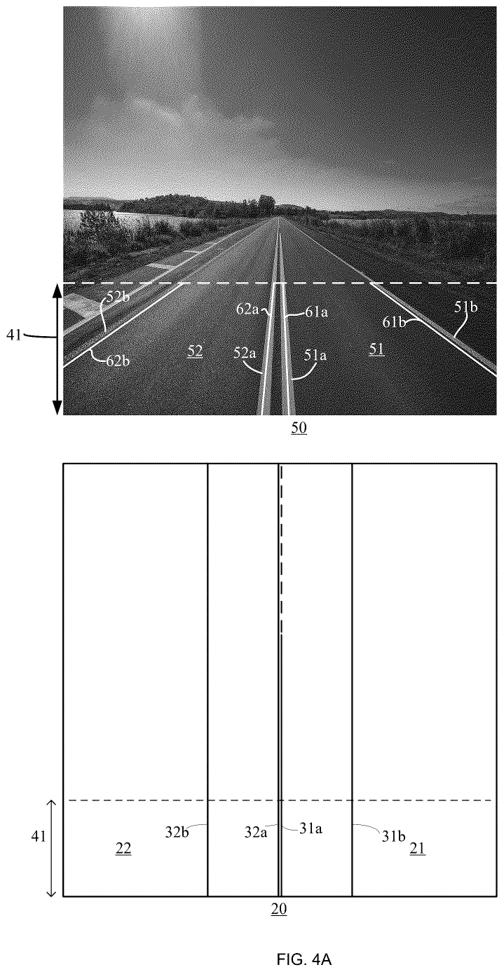

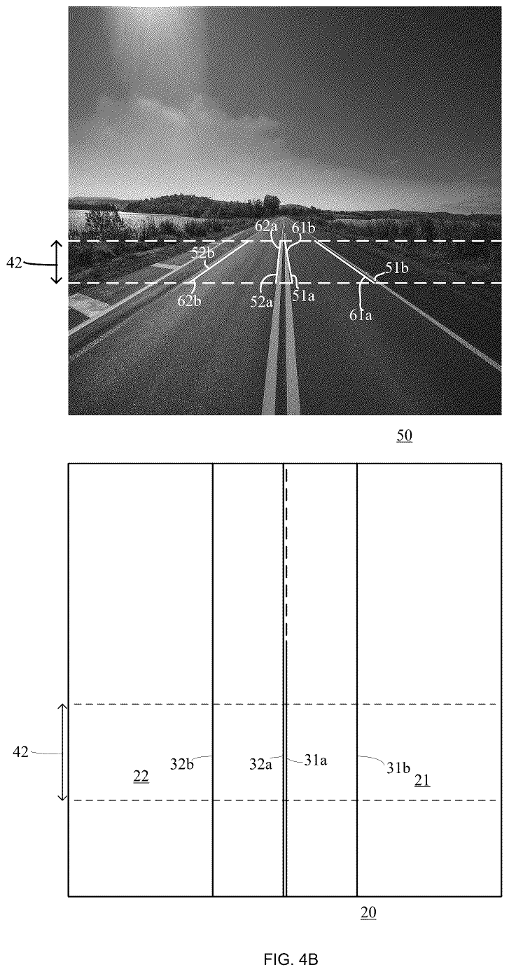

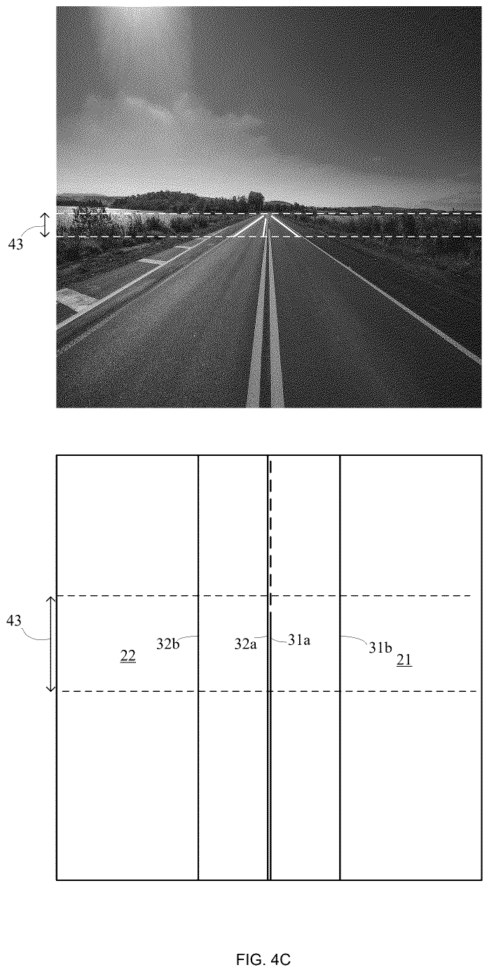

FIGS. 4A, 4B and 4C illustrate examples of three learning iterations. Where FIG. 4A illustrate a first distance range 41 associated with a given learning iteration, FIG. 4B illustrates a distance range increment 42 (in addition to the first distance range 41) associated with another learning iteration. FIG. 4C illustrates another range increment (in addition to the first distance range 41 and the distance range increment 42) associated with yet a further learning iteration.

FIGS. 4A, 4B and 4C include air based image 20 of an area or region that includes a dual lane road having first lane 21 delimited by air based first lane inner boundary 31a and air based first lane outer boundary 31b, and second lane 22 delimited air based second lane inner boundary 32a and air based second lane outer boundary 32b.

All three figures also include ground based image 50 of the area or region that includes the dual lane road having first lane 51 delimited by ground based first lane inner boundary 31a and ground based first lane outer boundary 31b, and second lane 55 delimited ground based second lane inner boundary 35a and ground based second lane outer boundary 35b.

In addition—the projections of the air based lane boundaries on the ground based image are also illustrated and include projection of air based first lane inner boundary 61a, projection of air based first lane outer boundary 61b, projection of air based second lane inner boundary 62a and projection of air based second lane outer boundary 62b.

The different figures illustrates examples of units and/or software and/or information items and/or steps and/or components. These examples are provided for brevity of explanation. At least one of the units and/or software and/or information items and/or steps and/or components is optional or mandatory.

The term obtaining include receiving and/or generating.

Artificial intelligence is used in relation to machines that mimic human intelligence and human cognitive functions like learning and problem solving. There are three types of artificial intelligence that include artificial super intelligence, artificial narrow intelligence and artificial general intelligence. Machine learning is a subset of artificial intelligence that allows for optimization. Deep machine learning is a subset of machine learning that uses larger datasets for training and learns in a different manner than not deep machine learning. Neural networks are a subset of machine learning and are used for implementing deep learning.

Any reference in the application to any of the terms “artificial intelligence”, “machine learning”, “deep learning” or “neural network” should be applied mutatis mutandis to any other term of “artificial intelligence”, “machine learning”, “deep learning” or “neural network”. For example—any reference to a neural network should be applied mutatis mutandis to artificial intelligence and/or should be applied mutatis mutandis to “machine learning”, and/or should be applied mutatis mutandis to “deep learning”.

Because some aspects of the illustrated embodiments of the present disclosure may, for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any combination of any steps of any method illustrated in the specification and/or drawings may be provided. Any combination of any subject matter of any of claims may be provided. Any combinations of systems, units, components, processors, sensors, illustrated in the specification and/or drawings may be provided. Any combination of any module or unit listed in any of the figures, any part of the specification and/or any claims may be provided.

Any reference in the specification to a method should be applied mutatis mutandis to a device or system capable of executing the method and/or to a non-transitory computer readable medium that stores instructions for executing the method. Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

In the foregoing specification, the invention has been described with reference to specific examples of embodiments of the invention. It will, however, be evident that various modifications and changes may be made therein without departing from the broader spirit and scope of the invention as set forth in the appended claims. The specifications and drawings are, accordingly, to be regarded in an illustrative rather than in a restrictive sense.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Those skilled in the art will recognize that boundaries between the above-described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of the underlying architecture or intermedial components. Likewise, any two components so associated can also be viewed as being “operably connected,” or “operably coupled,” to each other to achieve the desired functionality.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Thus, the scope of the embodiments of the disclosure is defined by the appended claims and equivalents thereof. While certain features of the disclosure have been illustrated and described herein, many modifications, substitutions, changes, and equivalents will now occur to those of ordinary skill in the art. It is therefore to be understood that the appended claims are intended to cover all such modifications and changes as fall within the true spirit of the invention.

We claim

1. A computer-implemented method of air to road bootstrap learning for driving, the method comprising:
obtaining, at a processor implementing a ground perception artificial intelligence model, road element location information for a given road element in air perception information of air based data that is collected at an identified location, in a region of view, wherein the road element location information is determined by using air to ground based localization of a vehicle in the region of view;
performing an iterative process of learning iterations for autonomous driving, while at each learning iteration increasing a distance range of the ground perception artificial intelligence model in the region of view associated with the learning iteration from preceding learning iterations to another,
wherein at each learning iteration of the iterative process:
inferring, using the road element location information, ground perception information for the given road element in the air perception information, by projecting the road element location information on a ground image pertaining to the given road object in the region of view; and
correcting, based on the inferring at each learning iteration and contingent on a determined detection threshold, a detection operation of a detector of the ground perception artificial intelligence model trained using ground data for detection of the given road element, by applying the ground image with the projected road element location information in the detection operation of the detector.

2. The computer-implemented method according to claim 1, wherein the inferring, at each learning iteration of the iterative process, the ground perception information is with respect to a distance range that is larger than a preceding learning iteration.

3. The computer-implemented method according to claim 1, wherein the detector is a lane detection model, and the ground perception information includes a lane marking.

4. The computer-implemented method according to claim 1, wherein the inferring, at each learning iteration of the iterative process, the ground perception information is in accordance with sensed data pertaining to a specified road segment.

5. The computer-implemented method according to claim 1, wherein the inferring, at each learning iteration of the iterative process, the ground perception information is further in accordance with sensed data pertaining to a determined driving scenario in the region of view.

6. The computer-implemented method according to claim 1, wherein the inferring, at each learning iteration of the iterative process, is further in accordance with sensed data obtained in driving of an additional vehicle in the region of view.

7. The computer-implemented method according to claim 1, wherein the inferring and the correcting is applicable at each learning iteration of the iterative process to a same region of view.

8. The computer-implemented method according to claim 1, wherein the inferring and the correcting is further applicable at each learning iteration of the iterative process to an additional region of view.

9. A computer-readable medium storing instructions that, when executable by at least one processing device, cause the processing device to:
obtain, at the processing device implementing a ground perception artificial intelligence model, road element location information for a given road element in air perception information of air based data that is collected at an identified location in a region of view, wherein the road element location information is determined by using air to ground based localization of a vehicle in the region of view;
perform an iterative process of learning iterations for autonomous driving, while at each learning iteration increasing a distance range of the ground perception artificial intelligence model in the region of view associated with the learning iteration from preceding learning iterations to another,
wherein at each learning iteration of the iterative process:
infer, using the road element location information, ground perception information for the given road element in the air perception information, by projecting the road element location information on a ground image pertaining to the given road object in the region of view; and
correct, based on the inferring at each learning iteration and contingent on a detection threshold, a detection operation of a detector of the ground perception artificial intelligence model trained using ground data for detection of the given road element, by applying the ground image with the projected road element location information in the detection operation of the detector.

10. The computer-readable medium according to claim 10, wherein the processing device is configured to infer, at each learning iteration of the iterative process, the ground perception information of a distance range that is larger than a preceding learning iteration.

11. The computer-readable medium according to claim 10, wherein the detector is a lane detection model, and the ground perception information includes a lane marking.

12. The computer-readable medium according to claim 10, wherein the processing device infers, at each learning iteration of the iterative process, the ground perception information in accordance with sensed data pertaining to a specified road segment.

13. The computer-readable medium according to claim 10, wherein the processing device infers, at each learning iteration of the iterative process, the ground perception information further in accordance with sensed data pertaining to a determined driving scenario in the region of view.

14. The computer-readable medium according to claim 10, wherein the processing device infers, at each learning iteration of the iterative process, is further in accordance with sensed data obtained in driving of an additional vehicle in the region of view.

15. The computer-readable medium according to claim 10, wherein the processing device infers, at each learning iteration of the iterative process, the ground perception information pertaining to a same region of view.

16. The computer-readable medium according to claim 10, wherein the processing device further applies the inferring and correcting, at each learning iteration of the iterative process, to an additional region of view.
